(19) United States
(12) Patent Application Publication
(10) Pub. No.: US 2003/0061301 A1
(43) Pub. Date: Mar. 27, 2003

(54) Music on demand system and method

(76) Inventors: Frank Chethik, Palo Alto, CA (US); Mark Ptak, Livermore, CA (US); Gregory Unangst, Mountain View, CA (US)

Correspondence Address: Keith D. Nelson, Lockheed Martin Corporation, Building 220, Mail Stop A08, P. O. Box 49041, San Jose, CA, 95161-9041, US

(21) Appl. No.: 09/962,667

(22) Filed: Sep. 25, 2001

(51) Int. Cl. G06F 15/16

(52) U.S. Cl. 709/217; 709/231

(57) ABSTRACT

A system and music distribution method that provides real-time distribution of CD quality music to subscribers in stationary and mobile environments. A subscriber unit is operative to format or generate a request for a music selection and uplink the formatted request to an audio service provider. The audio service provider validates the subscriber unit, encrypts the requested music selection, and downloads the encrypted music selection to the subscriber unit. The subscriber unit demodulates, decrypts and buffers an audio data stream comprising the music selection into a continuous digital signal. The subscriber unit D/A decodes the data stream to convert the decrypted music selection into an analog music signal that may be reproduced by a stereo system.

### BACKGROUND

The present invention relates generally to music systems and distribution methods, and more particularly, to an improved real-time music on demand system and music distribution method.

Prior art relating to the present invention includes the sale of compact disks (CDs), radio broadcasts, and Internet downloaded music files such as is available at spinner.com, for example. However, none of these prior art techniques provides high quality music on demand that is available to stationary and mobile users, and which provides music delivery in a manner similar to that of radio stations.

It is an objective of the present invention to provide for an improved real-time music on demand system and music distribution method.

### SUMMARY OF THE INVENTION

The present invention is a system and music distribution method that provides real-time distribution of CD quality music to subscribers in stationary and mobile environments. An exemplary real-time music on demand system comprises a subscriber unit that is operative to format a request for a music selection, uplink the formatted request, receive an encrypted digital music selection, decrypt the received digital music selection, and convert the decrypted digital music selection into an analog music signal that may be reproduced. A stereo system is coupled to the subscriber unit for reproducing the decrypted digital music selection. A digital audio service provider stores music selections in a digital format, receives and processes a request for one or more digital music selections, encrypts the one or more digital music selections in a manner that can be decrypted by a requesting subscriber unit, and transmits the one or more encrypted digital music selections to the requesting subscriber unit. A communication link is coupled between the subscriber unit and the digital audio service provider for communicating requests and requested digital music selections therebetween.

An exemplary music distribution method comprises the following steps. A request to download a music selection is generated by a subscriber at a subscriber unit. A communication link is established with an audio service provider. The request is uplinked to the audio service provider. The audio service provider receives the uplinked request. The received request is processed to validate the subscriber. Upon validation, the audio service provider encrypts the requested music selection. The audio service provider then downloads the encrypted music selection by way of the communication link to the subscriber unit. The subscriber unit demodulates, decrypts and buffers the audio data stream comprising the music selection into a continuous digital signal. The subscriber unit D/A decodes the data for input to the stereo system.

Each subscriber has total choice of selection, on demand, and with vely high digital quality. In particular, the present invention provides for a choice of music, in real time and on demand, with high quality, that is commercial free, and is compatible with home stereo and auto stereo systems.

The present invention provides for a real-time music on demand system and music distribution method. The real-time music on demand system comprises a subscriber unit that includes a programmer memory and display along with a keypad or other input device. The memory and display are coupled to an input/output device, such as a digital subscriber line (DSL) modem, for example, which interfaces by way of a telephone company or other communication link to an Internet service or digital audio service provider. Other input/output devices may be employed including a satellite transceiver, for example. The input/output device provides an interface to request and receive music from the digital audio service provider.

The memory and display are also coupled to an uplink buffer and formatter. The uplink buffer and formatter is coupled to a downlink buffer and decryptor. The downlink buffer and decryptor is coupled to a digital-to-analog (D/A) converter. The digital-to-analog (converter is coupled to a subscriber's stereo system either a home or vehicle stereo system.

Advantages of the present invention include the fact it does not involve the use of a computer and the necessary knowledge required to operate it. Music is distributed in real-time. There are Built-in safeguards for artists assuring a revenue stream for the artists. There is no storage requirement at the subscriber unit. The present invention uses an MPEG-3 audio stream to accurately reproduce the original audio source.

### BRIEF DESCRIPTION OF THE DRAWINGS

The various features and advantages of the present invention may be more readily understood with reference to the following detailed description taken in conjunction with the accompanying drawing figure, wherein like reference numerals designate like structural elements, and in which:

FIG. 1 is a block diagram illustrating an exemplary real-time music on demand system in accordance with the principles of the present invention;

FIG. 2 is a block diagram showing the architecture of an exemplary digital audio service provider of the music on demand system; and

FIG. 3 is a flow diagram that illustrates an exemplary music distribution method in accordance with the principles of the present invention.

### DETAILED DESCRIPTION

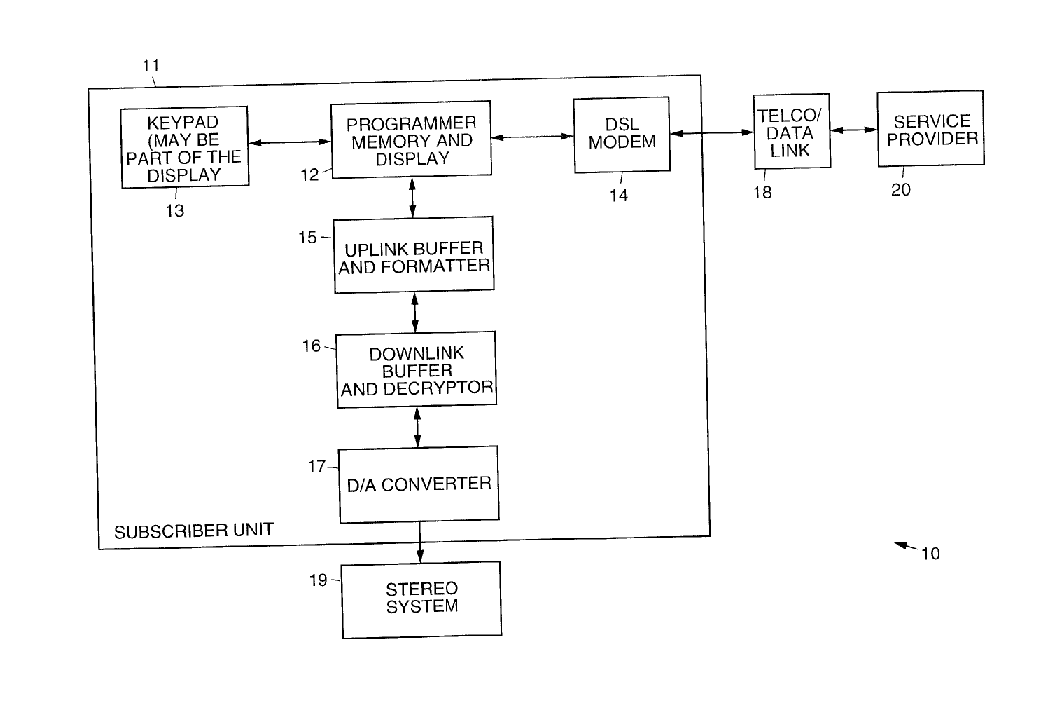

Referring to the drawing figures, FIG. 1 shows a block diagram of an exemplary real-time music on demand system 10 in accordance with the principles of the present invention. The real-time music on demand system 10 comprises a subscriber unit 11 which is coupled to a local stereo system 19, and to a digital audio service provider 20 (which may also be referred to as a wideband audio service provider (WASP) 20) by way of a communication link 18. The local stereo system 19 may be a home audio system or a vehicle audio system.

The digital audio service provider 20 stores music files, such as in a digital format, for example, which are selectively requested by a subscriber using the subscriber unit 11. The music files are stored and are transmitted in an encrypted manner that can be decrypted only by way of the subscriber unit 11.

The subscriber unit 11 comprises a programmer memory and display 12 which is coupled to a keypad 13. The keypad 13 may be part of the memory and display 12. The programmer memory and display 12 is coupled to a communication device 14, such as a digital subscriber line (DSL) modem 14, or other relatively high speed communication device 14. The communication device 14, or DSL modem 14, is selectively coupled to the communication link 18. The communication link 18 may be hard wired or optical link or may be a radio frequency (RF) or satellite link.

The programmer memory and display 12 is coupled to an uplink buffer and formatter 15. The uplink buffer and formatter 15 is operative to format and buffer requests for a music selection.

The programmer memory and display 12 is also coupled to a downlink buffer and decryptor 16. The downlink buffer and decryptor 16 is operative to buffer a received music selection and decrypt the received music selection so that it may be reproduced.

The downlink buffer and decryptor 16 is coupled to a digital-to-analog (D/A) converter 17. The D/A converter 17 is operative to convert the decrypted digital music selection derived from the downlink buffer and decryptor 16 into an analog music signal that may be reproduced by the stereo system 19.

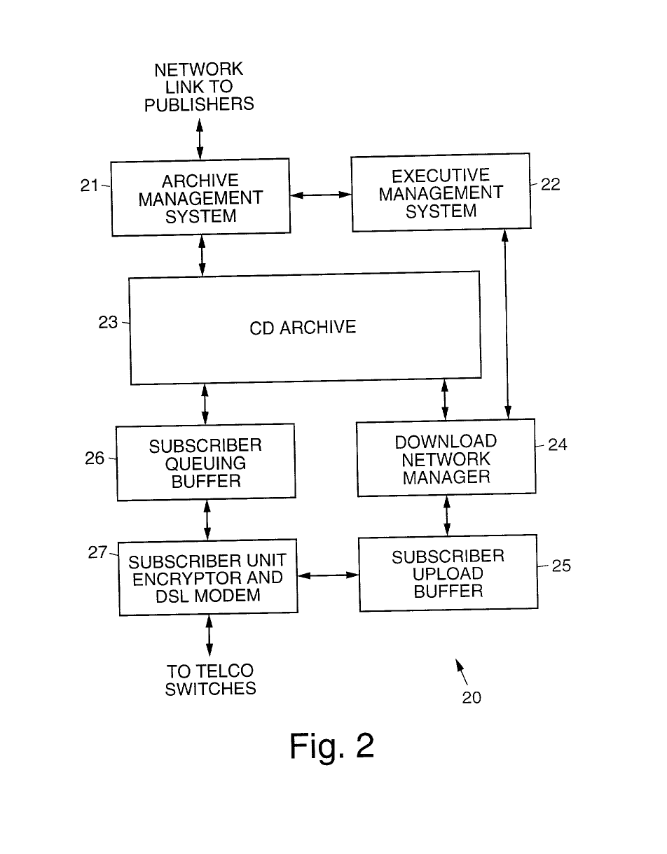

FIG. 2 is a block diagram showing the architecture of the digital audio service provider 20. The digital audio service provider 20 comprises an archive management system 21 that is coupled by way of a network link, for example, to music publishers. The archive management system 21 is coupled to an executive management system 22 and to a CD archive 23 that stores music files. The executive management system 22 is also coupled to a download network manager system 24.

The download network manager system 24 interfaces between the CD archive 22 and a subscriber upload buffer 25. A subscriber queuing buffer 26 (or output queuing buffer system 26) interfaces between the CD archive 22 and a subscriber unit encryptor and communication device 27 (such as a DSL modem) which communicates with subscriber units 11. The subscriber upload buffer is also coupled to the subscriber unit encryptor and communication device 27.

The digital audio service provider 20 performs a number of functions that include the following. The digital audio service provider 20 archives music files in the CD archive 22. The digital audio service provider 20 has systems that cooperate to store CD text files, write new text files of CD content from networks (received from publishers) and CD media, and access and download files to a designated output queuing buffer 26 or output queuing buffer system 26. The output queuing buffer system 26 or buffer 26 accesses the CD archive 22, and queues CD files to a download encryption system 27 comprising the subscriber unit encryptor and communication device 27.

The download encryption system 27 encrypts CD files output from the queuing buffer 26 and forwards them to the communication device (DSL modem transmitter) for transmission over the communication link 18. The download encryption system 27 handles subscriber encryption variables and sets up an encryption compatible with that subscriber unit 11 under control of the download network manager system 24.

The download network manager system 24 checks the status of the state and condition of the subscriber unit I 1, facilitates access of CD files from the CD archive 22 through the subscriber queuing buffer 26, manages the subscriber queuing buffer 26, and monitors the state of the communication link 18 (or DSL transmission network).

The executive manager system 22 monitors traffic for revenue measurands. monitors service provider functions and processes, supervises test modes, and status of subscriber units 11, subscriber billing and payment accounting. The subscriber upload buffer 25 handles subscriber requests and inputs to the archive management system 21 The real-time music on demand system 10 is designed for use by the audiophile market, and is used to implement an audio service wherein a listener requires no compact disks (CDs) or other recording medium or equipment. The listener instead subscribes to a monthly service, for example, wherein he or she transmits instructions (request) for a desired music selection in real time using the keypad 13. The request is formatted, and transmitted by way of the communications link 18 to the digital audio service provider 20. The request is answered by the digital audio service provider 20 which responds by transmitting a wideband digital audio file corresponding to the requested music over the communication link 18 to the requesting subscriber unit 11.

Each wideband digital audio file (either a single track or the entire content of a compact disk) is encrypted using a subscriber-unique code that allows that transmission to be received by only the intended subscriber unit 11. The user's subscriber unit 11 may be equipped with various degrees of sophistication based upon selection and queuing modes, and can be highly interactive with the digital audio service provider 20.

The service may publish a catalog and updates that can be made available to the subscribers through an Internet connection, conventional mail, or other media. The user system (subscriber unit 11) may be a fixed system adjunctive to a home stereo/audio system, or with lesser quality, a portable “Walkman-style player, for example.

The service is envisioned to require user subscriptions that permit use of the system 10. The user's subscription may be a limited one (say 100 hours per month) for a monthly fee of $10.00, for example, or an unlimited one (say, 720 hrs per month) for $20.00, for example. The subscriber's transceivers are designed to sell for less than $100.00 (for a portable unit) and as much as $500.00 for a fixed installation model, for example. An automotive model may cost as much as a fixed installation model. Transceiver costs may be handled in much the same manner as costs of DSL modems, cable tuners, and the like.

Using the present invention, the subscriber is relieved of the ownership of a typically large and expensive library of CDs that may represent a retail outlay of several thousands of dollars. In exchange, the user pays as much as $240.00 per year, for example, and may acquire a much larger audio library than could otherwise be afforded. Other billing plans may be arranged on an hourly basis or on a pay-per-play basis.

New recordings are available to subscribers as soon as they are published rather than the time delay associated with the normal music distribution system to react, and without requiring trips to record stores, or the like.

Using the present invention, music publishers are required to print and distribute many fewer copies of a release and thus their economics are favorably impacted. The wideband audio service provider (WASP) 20 meters the request statistics and pays royalties commensurate with the activity in any release and according to a prenegotiated schedule. The publishers gain instant feedback on the popularity of any release and may adjust their publicity and marketing accordingly in their traditional CD markets. Although the royalty payment per playing is small, the accumulated royalty over the life of a popular release may be enormous and may easily eclipse traditional royalties. It is believed that listeners are interested in the music, not the physical medium. The listeners pay for what they want to listen to.

The radio link connectivity for mobile users is estimated as follows. It is envisioned that the service provided using the present invention may be deployed on a metropolitan-area scale of about 100 square miles, using several transmission centers, supporting a subscriber population of say, 500,000, for example. It is assumed that only 30% of this population would be active at any moment. Assuming an average data rate of 500 Kbps per active channel, the system data rate is 75 Gbps. Assuming some geographic distribution permitting a frequency reuse of about a factor of 3 and a bandwidth efficiency of about 3 Bps/Hz, the overall bandwidth required for this service is thus 4.8 GHz. This bandwidth may grow to about 10 GHz when the inefficiencies of packetizing are included. The transmission band in the mid 70 GHz range may be employed. Alternatively, the region around 94 GHz may be desired, with some sacrifice in availability. Lower quality audio of an MP3 class of signals may require an individual transmission data rate of less than 100 Kbps. This reduces the channel bandwidth requirement to about 1.5 GHz.

The fixed user transmissions are easily accommodated over individual DSL connections via wideband modems operating over the telephone wire connections between telephone company local offices and their subscribers. Internet use is not required given that the host system of the wideband audio service provider 20 provides suitable connectivity to the local telephone company switches.

With regard to home stereo installations, the communications medium of the subscriber may be the equivalent of a DSL modem, or if the subscriber has a DSL modem, then that modem may be used. The stereo applique comprises a send unit and a receive unit that are embodied in the subscriber unit 11.

The send unit may assemble a subscriber's requests for music download and has associated memories that store file codes and perhaps musical program designators. The user that wants a particular program download selects the program, establishes connectivity with the wideband audio service provider 20, and uploads the request. The WASP center receives the request, validates the subscriber status and starts to download packetized audio (suitably encrypted) to the user's DSL address.

The user's receiver unit demodulates, decrypts and buffers the audio data stream into a continuous digital signal, and then D/A decodes the data for input to the stereo system 19. The decryption and D/A conversion is performed within a custom VLSI device so that at no time the clear text digitized audio is accessible to the user. Unauthorized copying of the digital audio files is virtually impossible.

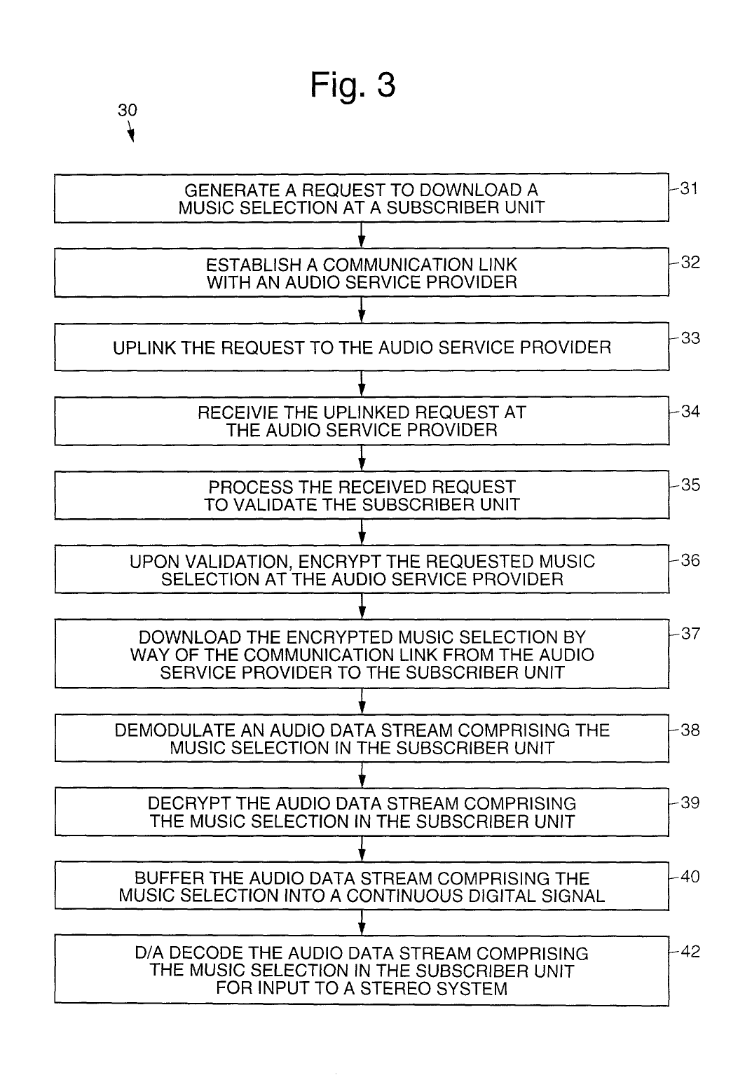

FIG. 3 is a flow diagram that illustrates an exemplary music distribution method 30 in accordance with the principles of the present invention. The exemplary music distribution method 30 comprises the following steps.

A request to download a music selection is generated 31 by a subscriber at a subscriber unit 11. A communication link is established 32 with an audio service provider 20. The request is uplinked 33 to the audio service provider 20.

The audio service provider 20 receives 34 the uplinked request. The received request is processed to validate 35 the subscriber. Upon validation, the audio service provider 20 encrypts 36 the requested music selection. The audio service provider 20 then downloads 37 the encrypted music selection by way of the communication link to the subscriber unit 11.

The subscriber unit 11 demodulates 38, decrypts 39 and buffers 40 an audio data stream comprising the music selection into a continuous digital signal. The subscriber unit 11 D/A decodes 41 the data for input to the stereo system 19.

Thus, a real-time music on demand system and music distribution method has been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. A real-time music on demand system comprising:
a subscriber unit that is operative to format a request for a music selection, uplink the formatted request, receive an encrypted digital music selection, decrypt the received digital music selection, and convert the decrypted digital music selection into an analog music signal that may be reproduced;
a stereo system coupled to the subscriber unit for reproducing the decrypted digital music selection;
a digital audio service provider that stores music selections in a digital format, receives and processes a request for one or more digital music selections, encrypts the one or more digital music selections in a manner that can be decrypted by a requesting subscriber unit, and transmits the one or more encrypted digital music selections to the requesting subscriber unit; and
a communication link coupled between the subscriber unit and the digital audio service provider for communicating requests and requested digital music selections therebetween.

2. The system recited in claim 1 wherein the stereo system comprises a home audio system.

3. The system recited in claim 1 wherein the stereo system comprises a vehicle audio system.

4. The system recited in claim 1 wherein the subscriber unit comprises:
a programmer memory and display;
a keypad coupled to the programmer memory and display;
a communication device coupled to the programmer memory and display.
an uplink buffer and formatter coupled to the programmer memory and display that is operative to format and buffer requests for a music selection;
a downlink buffer and decryptor coupled to the programmer memory and display that is operative to buffer a received music selection and decrypt the received music selection so that it may be reproduced; and
a digital-to-analog (D/A) converter coupled to the downlink buffer and decryptor that is operative to convert the decrypted digital music selection derived from the downlink buffer and decryptor into an analog music signal that may be reproduced by the stereo system.

5. The system recited in claim 1 wherein the keypad is part of the memory and display.

6. The system recited in claim 1 wherein the communication device 14 comprises a digital subscriber line (DSL) modem.

7. A real-time music on demand distribution method comprising the steps of:
generating a request to download a music selection at a subscriber unit;
establishing a communication link with an audio service provider;
uplinking the request to the audio service provider;
receiving the uplinked request at the audio service provider;
processing the received request to validate the subscriber unit;
upon validation, encrypting the requested music selection at the audio service provider;
downloading the encrypted music selection by way of the communication link from the audio service provider to the subscriber unit;
demodulating an audio data stream comprising the music selection in the subscriber unit;
decrypting the audio data stream comprising the music selection in the subscriber unit;
buffering the audio data stream comprising the music selection into a continuous digital signal; and
D/A decoding the audio data stream comprising the music selection in the subscriber unit for input to a stereo system.

8. The method recited in claim 7 wherein the stereo system comprises a home audio system.

9. The method recited in claim 7 wherein the stereo system comprises a vehicle audio system.
